(19) United States
(12) Patent Application Publication
(10) Pub. No.: US 2015/0193383 A1
(43) Pub. Date: Jul. 9, 2015

(54) AUTOMATED CREATION OF THEME-BASED IMAGE COMPILATIONS

(71) Applicant: Zoomin, Inc., Philadelphia, PA (US)

(72) Inventors: Srinivas Balijepalli RAO, Philadelphia, PA (US); Jae Hyung KIM, Irving, TX (US); Ketan Pravin SANGHVI, Mumbai (IN)

(21) Appl. No.: 14/590,628

(22) Filed: Jan. 6, 2015

Related U.S. Application Data
(60) Provisional application No. 61/923,901, filed on Jan. 6, 2014.

(51) Int. Cl. G06F 17/21

(52) U.S. Cl. CPC G06F 17/212

(57) ABSTRACT

An image processing system processes digital image files. The system organizes the images into sets of related images. The system stores information relating to various content, contextual and/or topical themes. The system's auto-theming engine matches an image set to one of various stored themes. Each theme is associated with backdrop images contextually matched to the assigned theme. The system stores information relating to various image layout templates. The system's auto-layout engine applies image layout templates defining positioning for the images in a foreground layer to be applied over a background layer comprising the backdrop image(s). The auto-layout engine selects and positions the images within the templates to create a compilation comprising the images arranged on a background that includes contextually-relevant imagery. The compilation may be designed for printing as a physical book (photobook) or poster, or may be configured as an electronic book, webpage/website, etc. for viewing in electronic format.

### CROSS-REFERENCE TO RELATED APPLICATION

This application claims the benefit of priority, under 35 U.S.C. §119(e) of U.S. Provisional Patent Application No. 61/923,901, filed Jan. 6, 2014, the entire disclosure of which is hereby incorporated herein by reference.

### FIELD OF THE INVENTION

The present invention relates generally to the field of computer systems, and more particularly to a computerized system and method configured to process digital photographic images and automatedly organize those images to identify a subset of the images having a common theme, and to automatedly create a theme-based display of the subset of images.

### BACKGROUND

The proliferation of digital cameras, and smartphones or other phones including digital cameras, has resulting in the capturing of numerous digital images. With this increase in the sheer volume of digital images, it has become increasingly difficult to manage, display and enjoy digital images in a meaningful fashion.

One popular way of displaying and enjoying captured digital images involves a user's manual review and selection of photographic images, and arrangement of such photographic images into an electronic or physical (printed) compilation, which is often printed and/or bound to create a photobook including one or more pages of images. Various commercial services exist that provide a web-based interface for manually reviewing, selecting and creating a photobook.

However, this process in typically very time-consuming, and in many cases, is a sufficiently burdensome task that the process is avoided. As a result, many digital images, once captured, are essentially lost in a large and growing storage archive, without ever being captured in a photobook.

What is needed is a system and method that simplifies the photobook creation process.

### SUMMARY

The present invention provides a system and method for automated creation of theme-based image compilations. The system and method can be used to simplify the photobook creation process. An image processing system is provided that processes digital image files. The system organizes the images into sets of related images. The system stores information relating to various content, contextual and/or topical themes. The system's auto-theming engine matches an image set to one of various stored themes. Each theme is associated with backdrop images contextually matched to the assigned theme. The system stores information relating to various image layout templates. The system's auto-layout engine applies image layout templates defining positioning for the images in a foreground layer to be applied over a background layer comprising the backdrop image(s). The auto-layout engine selects and positions the images within the templates to create a compilation comprising the images arranged on a background that includes contextually-relevant imagery. The compilation may be designed for printing as a physical book (photobook) or poster, or may be configured as an electronic book, webpage/website, etc. for viewing in electronic format.

### BRIEF DESCRIPTION OF THE FIGURES

An understanding of the following description will be facilitated by reference to the attached drawings, in which:

FIG. 1 is a diagram showing an exemplary networked computing environment including an image processing system in accordance with an exemplary embodiment of the present invention;

FIG. 2 is a diagrammatic view of exemplary backdrop images in accordance with the present invention;

FIG. 3 is a diagrammatic view of exemplary image layout templates in accordance with the present invention;

FIG. 4 is a diagrammatic view of an exemplary compilation in accordance with the present invention;

FIGS. 5 and 6 are diagrammatic views of exemplary pages of an exemplary photobook in accordance with the present invention;

FIG. 7 is a flow diagram illustrating an exemplary method for processing images to create a photobook in automated fashion, in accordance with the present invention; and

FIG. 8 is a schematic diagram showing an exemplary image processing system in accordance with an exemplary embodiment of the present invention.

### DETAILED DESCRIPTION

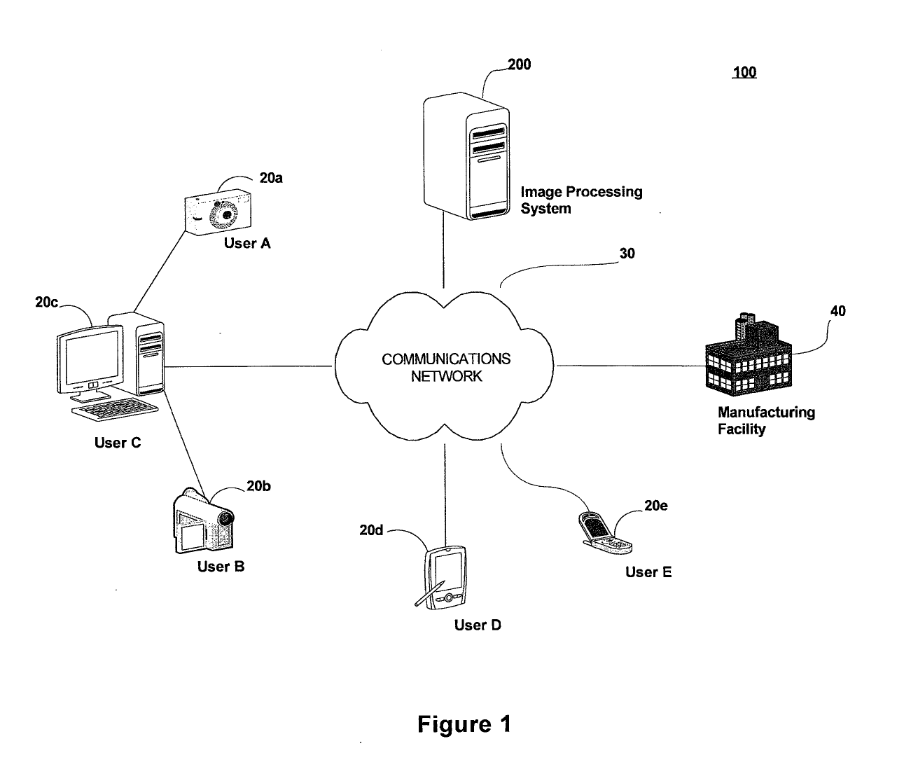

For illustrative purposes, an exemplary embodiment of the present invention is discussed below with reference to FIGS. 1-8. FIG. 1 is a schematic diagram showing an exemplary networked computing environment 100 including an image processing system 200 in accordance with an exemplary embodiment of the present invention.

As shown in FIG. 1, the networked computing environment 100 further includes computing devices operated by individual users such as a digital still camera 20a, a digital video-camera 20b, a personal computer 20c, a smartphone with camera capability 20d, and a conventional cellular camera phone 20e. These devices are conventional commercially-available devices that are generally capable of capturing, storing and/or transmitting digital images. As known in the art, computing devices 20a, 20b, are operable to communicate directly with personal computer 20c. Devices 20c, 20d, and 20e are capable of communication via the communications network with the IPS 200, e.g., to communicate captured digital images. Computer hardware and software for enabling such communication is well known in the art and beyond the scope of the present invention, and thus are not discussed in detail herein.

Referring again to the exemplary embodiment of FIG. 1, the networked computing environment 100 further includes a manufacturing facility 40, which is shown diagrammatically for ease of illustration. The manufacturing facility 40 is responsible for production of the photobook, poster or other articles in accordance with the compilation prepared by the IPS 200. The manufacturing facility 40 may include generally conventional manufacturing equipment and computing devices, e.g., for communication with IPS 200 via network 30, as well known in the art. Computer hardware and software, and other equipment, for enabling operation of the manufacturing facility 40 are well known in the art and beyond the scope of the present invention, and thus are not discussed in detail herein.

As referenced above and as described in further detail below, the IPS 200 receives images from one or more of the computing devices 20a-20e, processes those images in accordance with the present invention, and produces a theme-based compilation of digital images that are a subset of all images. Further, the IPS may enable transmission or display of the compilation for online or other viewing purposes, or enable transmission of the compilation to the manufacturing facility 40 to cause production of a printed photobook, or other physical object depicting the compilation.

In accordance with the present invention, digital images captured and/or stored by one of the devices 20a-20e are processed by the IPS system 200 and are automatedly organized by the system into one or more sets, such that all images in a set are related in some way. The system stores information relating to various content, contextual and/or topical themes. An auto-theming engine of the system automatedly matches the set to one of a predetermined set of themes stored by the system. Each theme is associated with one or more backdrop images. Each backdrop image is contextually matched to the assigned theme. The system further stores information relating to various image layout templates. An auto-layout engine of the system automatedly applies one or more image layout templates defining positioning for the images of the set in a foreground layer to be applied over a background layer comprising the backdrop image(s). Further, the auto-layout engine selects and positions the images within the image layout templates to created a compilation comprising the images arranged on a background that includes contextually-relevant imagery. Accordingly, for example, images from a Halloween party may be matched automatedly to a Halloween theme, and may be automatedly compiled into a compilation including the party images arranged on a backdrop including a contextually-relevant orange-and-black background including contextually relevant images of bats, witches, ghosts, jack-o-lanterns, etc. The compilation may be designed for printing as a physical book (photobook) or poster, or may be configured as an electronic book, webpage/website, etc. for viewing in electronic format.

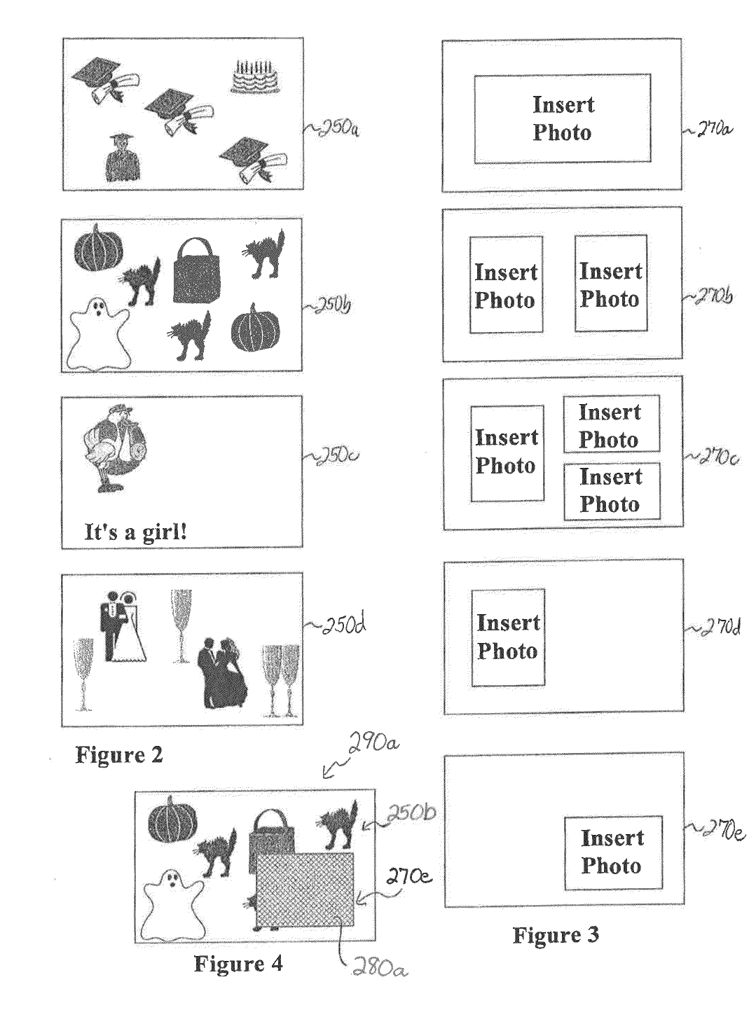

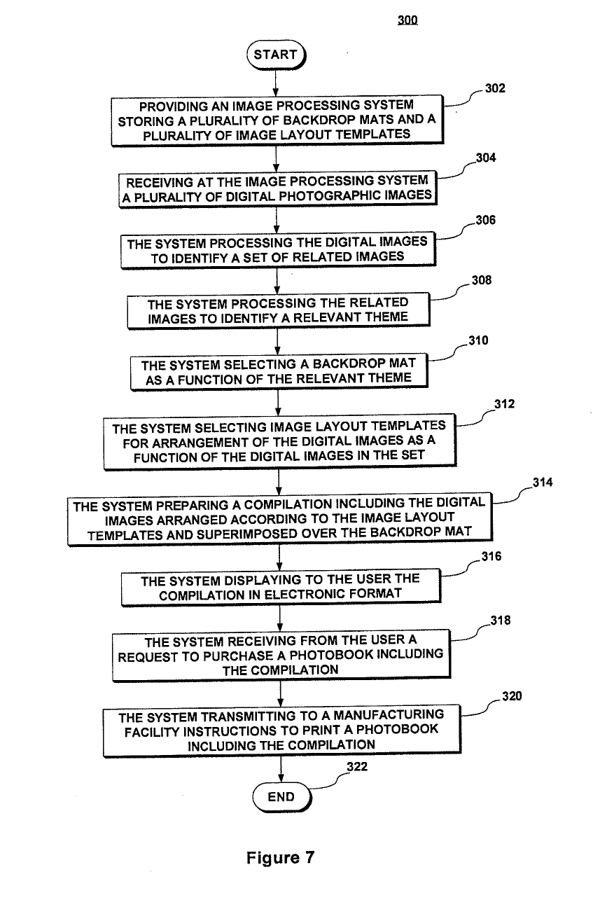

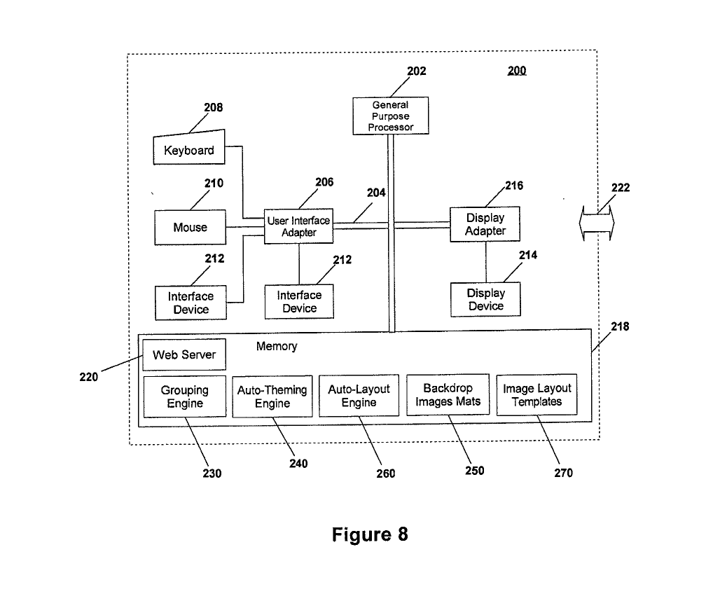

An exemplary method for creating a photobook in accordance with the present invention is discussed below in greater detail with reference to FIGS. 2-8. Referring now to the exemplary flow diagram 300 of FIG. 7, an exemplary method begins with providing an image processing system in accordance with the present invention, as shown at step 302. In this embodiment, the image processing system is provided as a server configured to provide processing of uploaded digital images in accordance with the present invention. Accordingly, in this embodiment, the image processing system is shown as IPS 200. It will be appreciated however, that in other embodiments, the image processing system may be implemented via software running on a client computing device, such as devices 20c-20e, e.g., via a smartphone software application.

In accordance with the present invention, the IPS 200 stores in its memory 218 a plurality of backdrop mats, e.g., in data store 250, as shown in FIG. 10. Exemplary backdrop mats 250a-250d are shown in FIG. 2. Each backdrop mat includes colors, graphics/images, stock photographs and/or text that are contextually relevant to a theme. For example, backdrop mat 250a corresponds to a “graduation” theme, and includes images of a cake, a mortarboard, a diploma, etc.—which are contextually relevant to a graduation theme. By way of further example, backdrop mat 250c includes images of a stork, a baby, and the text “It's a girl!”—which are contextually relevant to a “newborn baby” theme. Each backdrop mat provides a continuous arrangement of graphical elements that may be used as a backdrop or conceptual “mat” for a conceptual album page, without any indication to position, placement or size of any images.

The IPS 200 further stores in its memory 218 a plurality of image layout templates, e.g., in data store 270, as shown in FIG. 9. Exemplary image layout templates 270a-270e are shown in FIG. 3. Each image layout template includes predefined fields of predefined positions and sizes for receiving digital images captured by users. For example, image layout template 270a is configured to receive a single image in landscape format, in a position central to a conceptual page element. By way of further example, image layout template 270c is configured to receive a first image in portrait format on the left side of a page, and two images in landscape format positioned in an over/under arrangement on the right side of a page. Each image layout template provides a template for position, placement and size of images on a conceptual album page, without including any theme/context-specific images, text, etc. Accordingly, the image layout templates are separate and distinct from the backdrop mats.

Referring again to FIG. 7, the method further includes receiving at the IPS 200 a plurality of digital photographic images. This may be all, or many, generally unsorted photographic images. For example, it may include all images in an “album”, or all images since a last download of images, or all images within the last predetermined time period (e.g. 3 months). Such receiving may involve providing access to a client-side IPS, or uploading digital images from a client computing device to an network-based IPS 200, as contemplated in FIG. 1.

The system then processes the digital images to identify a set of related images, as shown in FIG. 7 at 306. This may be performed in any suitable fashion, many of which are known in the art. For example, digital photographic images may include EXIF or other metadata data as part of an image file. By way of example, such metadata often includes GPS/locational coordinates, a time/date stamp, etc. Such information may be used, for example, to gather photographs deemed to be related because they were taken at the same place (as determined by locational coordinates and/or rules) or at the same time (e.g., as determined by time stamp data and/or rules). Other methods for determining relatedness may involve image analysis to determine common colors/settings, common faces/people/subject matter, etc. For example, if 100 photographs are processed (e.g., from the preceding month), and it is determined in this step that 25 digital images are related because they were taken at the same geographic location, then in this step, these 25 images may be identified as a set of related images. This step may be performed by a grouping engine 230 provided via instructions stored in the memory 218 of the IPS 200. The grouping engine 230 includes rules for identifying which images are related. Any suitable rules may be used. For example, rules may provide that images taken within a single hour are related, or taken within a 500 foot radius are related, or taken within a single hour within a 500-foot radius are related, etc. Any suitable rules and/or grouping methodology may be used in accordance with the present invention.

Referring again to FIG. 7, the system 200 then processes the set of related images identified in 306 to identify a relevant theme, as shown at 308. This may be performed by an auto-theming engine 240 of the IPS 200. The auto-theming engine comprises instructions stored in the memory 218 of the IPS 200. The auto-theming engine automatedly assigns a theme to the set of related images by reference to a table associating themes with metadata associated with one or more of the digital images. Entries in the table may include entries taken from a predetermined calendar of events, or user profile data provided by the user to system, or gathered by the system from other sources, such as social networking or other websites (such as Facebook) including user profile data, or from a user's personal/private calendar of events. For example, if date information extracted from the digital images is 10/31, then the table may associate that date with a Halloween theme in view of a Halloween holiday entry on a predetermined calendar of events (e.g., including national holidays and other widely-recognized holidays/dates/events). By way of further example, a personal calendar may indicate that 11/5 is the user's wedding anniversary date. In this case, the table may associate 11/5 with a wedding anniversary theme for that particular user. By way of further example, gender, age, marital status, children, etc. may be provided to the system as part of a user's profile associated with a user account for use of the system, or may be gathered by the system from external sources, e.g., by gathering such information from a Facebook page or other social networking/other website, which typically includes such information as part of a personal profile associated with the user. By way of example, a “male anniversary” theme may be recognized separately from a “female anniversary” theme. Similarly, age may be used to vary an anniversary theme—for example to account for respective preferences of younger and older couples. The auto-theming engine may be configured with any suitable rules for assigning a theme in accordance with the present invention.

Referring again to FIG. 7, the system next selects a backdrop mat as a function of the relevant theme, as shown at 310. This selection is made by the auto-theming engine 240. For example, if a graduation theme has been assigned, the system may select a graduation backdrop mat 250a having imagery contextually-relevant to a graduation theme, as shown in FIG. 2. By way of alternative example, if a Halloween theme has been assigned, the system may select a Halloween backdrop mat 250b having imagery contextually-relevant to a Halloween theme, as shown in FIG. 2. The system selects one or more suitable backdrop mats from the available backdrop mats stored in a backdrop image data store 250 in the memory 218 of the system. It will be noted that the available backdrop mats may include more than one backdrop mat for each theme. The backdrop mats will be used as backgrounds for a compilation including the set of images. In one example, a single backdrop mat is used as the background for all pages of a single photobook. In another example, multiple different backdrop mats (each corresponding to a common theme) are used for multiple different pages (and/or covers) of a single photobook. Backdrop mats may also include text, stock images, etc. and may define color-palette, fonts, borders, or other aspects of the overall “look” for a compilation.

Referring again to FIG. 7, the system next selects one or more image layout templates as a function of the digital images contained in the set, as shown at 312. This selection is made by the auto-layout engine 260. The system selects one or more suitable image layout templates from the available image layout templates stored in an image layout template data store 270 in the memory 218 of the system. It will be noted that the image layout templates may include various arrangements for images of different sizes, orientations, and placements.

It will be noted that the auto-layout engine 260 selects the image layout templates as a function of the digital images contained in the set. For example, if the set includes 20 digital images, the auto-layout engine 260 may select image layout templates for accommodating/displaying 20 digital images. It will be appreciated that different combinations of templates may be selected for displaying 20 images. For example, 20 templates may be selected that display only one image each, or 10 templates may be selected that display two images each, or 5 templates may be selected that display four images each, etc. Accordingly, the auto-layout engine 260 may select the image layout templates as a function of the number of the digital images contained in the set.

It will be further appreciated that each image may have a portrait or landscape orientation, and that it may be desirable to match the orientation of each image to templates having fields with corresponding orientations so that, for example, each image with a portrait orientation is arranged in a template having a field with a portrait orientation. Accordingly, the auto-layout engine 260 may select the image layout templates as a function of the orientation of the digital images contained in the set. Further, each image may depict faces, and face detection software may be used to identify the position of one or more faces in an image, and such face position information may be used by the auto-layout engine 260 to select an image layout template.

Referring again to FIG. 7, the system next prepares at least one compilation including the digital images, as shown at 314. The compilation includes the digital images from the set (or a subset of the images of the set after automated elimination of duplicative images, low quality images etc., which may be performed according to conventional techniques beyond the scope of the present invention), with those images positioned according to the selected image layout templates, and superimposed over the selected backdrop image mat(s). An exemplary single-page compilation 290a includes an exemplary image 280a positioned according to image layout template 270e superimposed over backdrop image mat 250b is shown in FIG. 4.

The system then displays to the user the compilation in electronic format, as shown at 316. This may involve, for example, transmitting data via the communications network to a user's computing device, such as PC 20c or smartphone 20d, e.g., for display via a web browser of the user's computing device. The compilation may be displayed in “mock-up” form to represent an actual photobook, etc., and thus may allow a user to navigate the book interactively to view, for example, each page of the photobook.

Along with the display of the compilation, the system presents to the user an option to approve/purchase the compilation. This may be performed in any suitable fashion, but preferably requires little more than a single action, such as a touch, or click of a mouse, to approve and purchase the proposed compilation/photobook. Optionally, however, the system provides a graphical user interface via the web browser that allows the user to interact with and edit the proposed photobook, e.g., to add text, delete/replace/add digital images, change covers/binding, etc.

In this example, the system next receives from the user a request to purchase the proposed (or edited) compilation, e.g., in photobook form, as shown at 318. This request may arrive in any suitable form representing the user's intention to produce and pay for the compilation. In response to this request, the system transmits to a manufacturing facility 40 instructions to print the compilation (e.g., photobook) including the compilation, as shown at 320, and the method ends, as shown at 322. In the example of FIG. 1, this involves transmitting instructions via the communications network 30 to the manufacturing facility 40. In other embodiments, the system 200 may be integrated within the manufacturing facility 40.

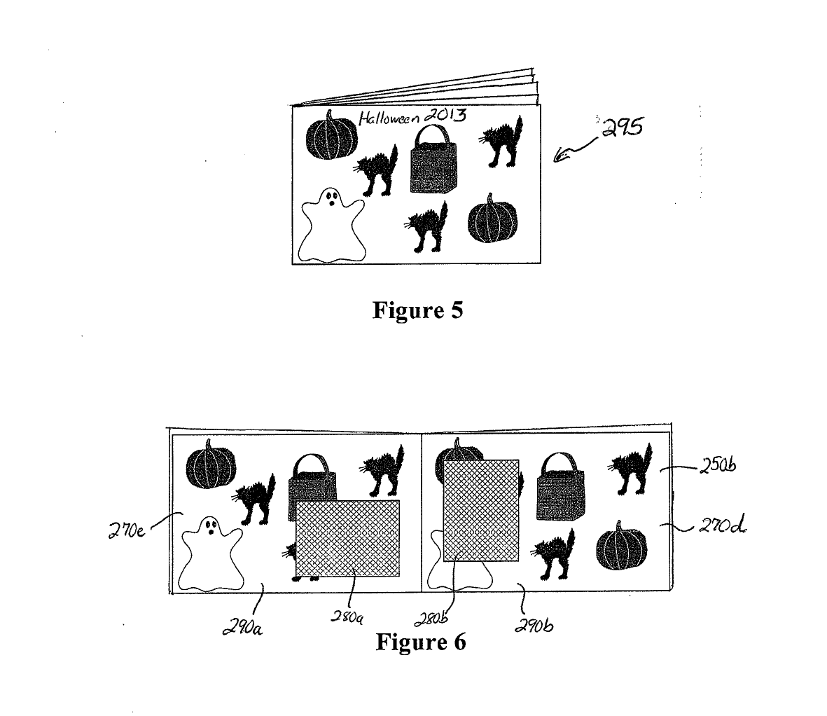

It should be appreciated that the exemplary compilation 290a of FIG. 4 is provided for illustrative purposes a single “sheet,” and, by way of example, could be printed as a poster, or could be included as part of a multi-page compilation suitable for binding as a photobook, etc. FIG. 5 shows an exemplary photobook 295 including a cover using the same Halloween-themed template 250b, and also additional text (a title, “Halloween 2013”). FIG. 6 shows an exemplary photobook 295 including a multi-page compilation including pages 290a, 290b that include different digital images 280a, 280b arranged according to different image layout templates, 270e, 270d, but both superimposed over backdrop mate 250b. This arrangement into a compilation is performed by the auto-layout engine 260.

In some embodiments, the auto-layout engine 260 is configured to select image layout templates as a function not only of the digital images contained in the set, but also according to a price point. For example, printed photobooks with relatively more pages are generally more expensive to produce than printed photobooks with relatively fewer pages. Accordingly, the auto-layout engine 260 may be configured to select image layout templates (including from among templates without images, and from among templates and/or options for various covers/cover materials/styles) to conform to a desired price point for the photobook. The price point may be inferred from user profile data (including a preference setting). For example, profile data may suggest a higher of lower price point as a target price point. Alternatively the target price point may be a predetermined system setting that is a standard for all buyers/users (e.g., $30). Alternatively, the target price point may be determined according to predetermined logic of the system (e.g., via a budgeting engine implemented via code/information stored in the memory 218 of the IPS 200), as a function of the number and/or size of images to be included in a photobook. In certain embodiments, the system provides the user with a graphical user interface allowing the user to specify a price point for the photobook, and the system responsively creates a compilation/photobook meeting the price point.

For example, if the target price point is $30, it may be possible to select templates presenting one image per template for a small set of images, but may be necessary to select templates presenting more than one image per template for a larger set of images. Further, template selection may involve selecting a printing style/quality, a binding style/quality, and/or a cover style/quality. For example, a staple-bound photobook with a soft-cover may provide a lower price point photobook, while an edge-bound photobook with a hard cover may provide a higher prior point.

In certain embodiments, the system 200 is configured to automatedly produce more than one compilation with varying numbers of images, images per page, pages, binding and/or cover, and to present a range of photobook options, corresponding to multiple different price points. For example, the system may be preconfigured to produce three different compilations that may be used to create three different photobooks may be presented at low, moderate, and high price points, the moderate price point being selected to correspond to the target price point. For example, the digital images may be used to produce a compilation having the fewest possible pages with the available templates, and to use a soft cover and staple binding to product a low-price point photobook, and the digital images may be used to product a second compilation having the most possible pages with the available templates (or according to other rules), and to use a hard cover and edge binding to produce a high price point photobook. The system may be configured to automatedly produce multiple compilations and present multiple photobook options to the user. The user may be presented with options to choose one of the presented photobooks when reviewing the compilations and/or requesting purchase of a photobook.

FIG. 8 is a schematic diagram showing an exemplary image processing system (IPS) 200 in accordance with an exemplary embodiment of the present invention. The IPS 200 is shown logically in FIG. 1 a single representative server for simplicity of illustration only. The IPS 200 includes conventional server hardware storing and executing specially-configured computer software for carrying out a method in accordance with the present invention. Accordingly, the exemplary IPS 200 of FIG. 10 includes a general purpose microprocessor (CPU) 202 and a bus 204 employed to connect and enable communication between the microprocessor 202 and the components of the IPS 200 in accordance with known techniques. The exemplary IPS 200 includes a user interface adapter 206, which connects the microprocessor 202 via the bus 204 to one or more interface devices, such as a keyboard 208, mouse 210, and/or other interface devices 212, which can be any user interface device, such as a touch sensitive screen, digitized entry pad, etc. The bus 204 also connects a display device 214, such as an LCD screen or monitor, to the microprocessor 202 via a display adapter 216. The bus 204 also connects the microprocessor 202 to memory 218, which can include a hard drive, diskette drive, tape drive, etc.

The IPS 200 may communicate with other computers or networks of computers, for example via a communications channel, network card or modem 222. The IPS 200 may be associated with such other computers in a local area network (LAN) or a wide area network (WAN), and may operate as a server in a client/server arrangement with another computer, etc. Such configurations, as well as the appropriate communications hardware and software, are known in the art.

The IPS is specially configured in accordance with the present invention. Accordingly, in the example of FIG. 8, the IPS 200 includes computer-readable, microprocessor-executable instructions stored in the memory 218 for carrying out the methods described herein. Further, the memory stores certain data, e.g. in databases or other data stores shown logically in FIG. 8 for illustrative purposes, without regard to any particular embodiment in one or more hardware or software components. For example, FIG. 8 shows schematically storage in the memory 218 of web server software 220, a grouping engine 230 including data processing logic for processing images and grouping them into one or more sets, an auto-theming engine 240 including data processing logic for assigning a theme to at least one set, an auto-layout engine 260 including data processing logic for selecting images of the set, selecting image layout templates, and preparing compilations, a backdrop image data store 250 including backdrop images 250a, 250b, 250c, etc., and a page layout data store 270 including page layouts 270a, 270b, 270c, 270d, 270e, etc.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

In the exemplary embodiment described above, images are uploaded to a central system, and certain processing is performed at the central system. It should be noted, however, that in alternative embodiments one or more of the steps described as occurring at the central system may alternatively be performed at the client device.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. A method for creating a theme-based photobook, the method comprising:
providing an image processing system comprising a memory and a processor, said system storing in its memory a plurality of backdrop mats and a plurality of image layout templates;
receiving, at the system, a plurality of digital images;
processing, at the system, the digital images to identify a set of related images, said set being a subset of said plurality of digital images;
processing, at the system, the set of related images to identify a theme common to said images;
selecting, at the system, at least one of said plurality of backdrop mats as a function of the theme;
selecting, at the system, at least one of said plurality of image layout templates as a function of the images in the set of related images;
preparing a compilation comprising the related images arranged according to at least one selected image layout template, the related images being superimposed over at least one selected backdrop mat;
in response to a signal provided by a user, the system transmitting to a manufacturing facility instruction to print a photobook including the compilation.

2. The method of claim 1, wherein said preparing a compilation is performed at the system.

3. The method of claim 1, wherein the image processing system comprises a client computing device.

4. The method of claim 3, wherein the client computing device comprises a smartphone.

6. The method of claim 1, wherein the image processing system comprises a central system capable of communicating via a communications network.

7. The method of claim 6, wherein the image processing system is configured as a web server.

8. The method of claim 1, further comprising:
selecting, at the system, an image layout template as a function of a target price point target.

9. The method of claim 8, wherein said target price point is specified by a user.

10. The method of claim 8, wherein said target price point is inferred from user profile data.

11. The method of claim 8, wherein said target price point is a predetermined system setting applicable to multiple users.

12. The method of claim 8, wherein said target price point is determined according to predetermined logic of the system as a function of at least one of a number of images and size of images to be included in a photobook.

13. The method of claim 8, further comprising automatedly producing a plurality of compilations, each compilation corresponding to one of a plurality of unique price points.

14. The method of claim 13, wherein said plurality of compilations differ in at least one of a page count, an image count, an image size, a printing style, a printing quality, a binding style, a binding quality, and a cover style, and a cover quality.

15. The method of claim 13, wherein each of said plurality of compilations corresponds to a respective one of a low price point, a moderate price point, and a high price point.

16. The method of claim 15, wherein the moderate price point corresponds to the target price point.

17. An image processing system for automated creation of theme-based image compilations, the system comprising:
a microprocessor;
a memory operatively connected to the microprocessor; and
a plurality of backdrop mats stored in the memory, each of said plurality of backdrop mats providing a continuous arrangement of graphical elements that may be used as a backdrop for an image, without any indication of position, placement or size of said image;
a plurality of image layout templates stored in the memory, each image layout template providing a template for position, placement and size of images without including any theme-specific content;
instructions stored in the memory and executable by the microprocessor to provide a grouping engine configured for processing a plurality of digital images to identify a set of related images, the set being a subset of the plurality of digital images, the grouping engine comprising rules for determining which images are related;
instructions stored in the memory and executable by the microprocessor to provide an auto-theming engine configured for processing the set of related images to identify a theme common to the set of images, and to automatedly assign a theme to the set, the auto-theming engine comprising rules for assigning a theme;
instructions stored in the memory and executable by the microprocessor to cause the auto-theming engine to select at least one of said plurality of backdrop mats as a function of the assigned theme;
instructions stored in the memory and executable by the microprocessor to provide an auto-layout engine configured for selecting at least one of said plurality of image layout templates as a function of the digital images contained in the set; and
instructions stored in the memory and executable by the microprocessor to cause the auto-layout engine to prepare a compilation comprising the related images arranged according to at least one selected image layout template, the related images being superimposed over at least one selected backdrop mat.

18. The system of claim 17, wherein said instructions stored in the memory to provide the auto-theming engine comprise instructions for assigning a theme by referencing a table associating themes with metadata associated with one or more of the digital images.

19. The system of claim 17, further comprising instructions stored in the memory and executable by the microprocessor to cause display of the compilation via a graphical user interface.

20. The system of claim 17, further comprising instructions stored in the memory and executable by the microprocessor to provide a graphical user interface for displaying the compilation as an interactive photobook.

21. The system of claim 20, further comprising instructions stored in the memory and executable by the microprocessor to provide a graphical user interface via a web browser that allows a user to interact with and edit the photobook.

22. The system of claim 17, further comprising instructions stored in the memory and executable by the microprocessor to cause, in response to a signal provided by a user, the system to transmit to a manufacturing facility instructions to print a photobook including the compilation.

23. The system of claim 17, wherein said instructions stored in the memory to provide the auto-layout engine further comprise instructions for configuring the auto-layout engine to select image layout templates as a function not only of the digital images contained in the set, but also according to a price point.

24. The system of claim 23, wherein said instructions stored in the memory to provide the auto-layout engine comprise instructions to infer the price point from user profile data.

25. The system of claim 23, wherein said instructions stored in the memory to provide the auto-layout engine comprise instructions to use a predetermined price point in accordance with a predetermined system setting that is a standard for all buyers/users.

26. The system of claim 23, wherein said instructions stored in the memory to provide the auto-layout engine comprise instructions to use a predetermined price point determined according to predetermined logic of the system as a function of at least one of the number and size of images in the compilation.

27. The system of claim 23, wherein said instructions stored in the memory to provide the auto-layout engine comprise instructions provides a user with a graphical user interface allowing the user to specify the price point.

28. The system of claim 17, further comprising instructions stored in the memory and executable by the microprocessor to automatedly produce a plurality of compilations having varying numbers of images, images per page, pages, binding and/or cover, and to present a range of photobook options, each corresponding to a respective one of a plurality of different price points.

29. An image processing system for automated creation of theme-based image compilations, the system comprising:
a microprocessor;
a memory operatively connected to the microprocessor; and
instructions stored in the memory and executable by the microprocessor to cause the system to:
receive a plurality of digital images;
process the digital images to identify a set of related images, said set being a subset of said plurality of digital images;
process the set of related images to identify a theme common to said images;
select at least one of said plurality of backdrop mats as a function of the theme;
select at least one of said plurality of image layout templates as a function of the images in the set of related images;
prepare a compilation comprising the related images arranged according to an image layout template.
